(19) United States
(12) Patent Application Publication
(10) Pub. No.: US 2023/0316400 A1
(43) Pub. Date: Oct. 5, 2023

(54) DATA COMPARISON METHOD AND APPARATUS, DEVICE AND STORAGE MEDIUM

(71) Applicant: FUTU NETWORK TECHNOLOGY (SHENZHEN) CO., LTD., Shenzhen (CN)

(72) Inventor: Jucheng ZHOU, Shenzhen (CN)

(21) Appl. No.: 18/299,025

(22) Filed: Apr. 11, 2023

Related U.S. Application Data
(63) Continuation of application No. PCT/CN2022/089964, filed on Apr. 28, 2022.

(30) Foreign Application Priority Data
Jun. 17, 2021 (CN) 202110673176.3

(51) Int. Cl. G06Q 40/04; G06F 3/0482; G06F 3/0483; G06T 11/20; G06F 3/0488; G06F 3/0484

(52) U.S. Cl. CPC G06Q 40/04; G06F 3/0482; G06F 3/0483; G06T 11/206; G06F 3/0488; G06F 3/0484

(57) ABSTRACT

Provided are a data comparison method and apparatus, a device, and a storage medium. The method includes receiving a stock comparison instruction in response to a first operation from a user, and displaying a stock comparison page. The stock comparison page includes a menu view including a stock name column and a data index selection list column, and TOW views corresponding to the menu view. The data index selection list column includes at least two data indexes each including at least one index. A row view corresponding to the stock name column includes at least two first bar sub-views each used to display a button for adding a to-be-compared stock or display a name of the to-be-compared stock and a delete button. A row view corresponding to each of the at least one index includes at least two second bar sub-views each used to display data of each of the at least one index of each to-be-compared stock.

### CROSS-REFERENCE TO RELATED APPLICATIONS

The present application is a continuation of International Application No. PCT/CN2022/089964, filed on Apr. 28, 2022, which claims priority to Chinese Patent Application No. 202110673176.3 titled “DATA COMPARISON METHOD AND APPARATUS, DEVICE AND STORAGE MEDIUM”, filed on Jun. 17, 2021 with China National Intellectual Property Administration, which is incorporated herein by reference in its entirety.

### FIELD

The present disclosure relates to the technical field of Internet, and more particularly, to a data comparison method and apparatus, a device, and a storage medium.

### BACKGROUND

A stock is a certificate of ownership issued by a joint-stock company, and is a kind of securities issued by the joint-stock company to all shareholders as a certificate of shareholding and obtained dividends and bonuses in order to raise funds. The stock plays an increasingly important role in economic development, and more and more people regard the stock as an important investment option. At present, there are many stocks for a user to choose in the market. With the development of science and technology, many stock applications (APPs) have emerged. The user may view the relevant data of different stocks by the stock APPs, and then select stocks that match their own investment level from a large number of stocks.

In the related art, most of the stock APPs may provide a stock comparison function, which can compare prices of a plurality of stocks selected by the user or of all current stocks, specifically displaying a name and corresponding price of each stock through a display page on an electronic device.

However, the user needs to know more stock comparison data in order to make an accurate choice, and the existing stock comparison function has less data indexes and is not comprehensive enough.

### SUMMARY

The present disclosure provides a data comparison method and apparatus, a device and a storage medium to solve the problem that there are few data indexes for stock comparison.

In a first aspect according to embodiments of the present disclosure, there is provided a data comparison method including receiving a stock comparison instruction in response to a first operation from a user, and displaying a stock comparison page. The stock comparison page includes a menu view and row views corresponding to the menu view. The menu view includes a stock name column and a data index selection list column. The data index selection list column includes at least two data indexes, and each of the at least two data indexes includes at least one index. A row view corresponding to the stock name column includes at least two first bar sub-view, and each of the at least two first bar sub-views is used to display a button for adding a to-be-compared stock or display a name of the to-be-compared stock and a delete button. A row view corresponding to each of the at least one index includes at least two second bar sub-views, and each of the at least two second bar sub-views is used to display data of each of the at least one index of each to-be-compared stock.

In a second aspect according to embodiments of the present disclosure, there is provided a data comparison apparatus including a receiving module and a processing module. The receiving module is configured to receive a stock comparison instruction in response to a first operation from a user. The processing module is configured to display a stock comparison page. The stock comparison page includes a menu view and row views corresponding to the menu view. The menu view includes a stock name column and a data index selection list column. The data index selection list column includes at least two data indexes, and each of the at least two data indexes includes at least one index. A row view corresponding to the stock name column includes at least two first bar sub-views, and each of the at least two first bar sub-views is used to display a button for adding a to-be-compared stock or display a name of the to-be-compared stock and a delete button. A row view corresponding to each of the at least one index includes at least two second bar sub-views, and each of the at least two second bar sub-views is used to display data of each of the at least one index of each to-be-compared stock.

In a third aspect according to embodiments of the present disclosure, there is provided an electronic device including a processor and a memory configured to store instructions executable by the processor. The processor is configured to execute the executable instructions to perform the data comparison method in the first aspect or any one of the embodiments of the first aspect.

In a fourth aspect according to embodiments of the present disclosure, there is provided a computer-readable storage medium having a computer program stored thereon. The computer program, when executed by a processor, implements the data comparison method in the first aspect or any one of the embodiments of the first aspect.

In a fifth aspect according to embodiments of the present disclosure, there is provided a computer program product including a computer program. The computer, when executed by a processor, implements the data comparison method in the first aspect or any one of the embodiments of the first aspect.

In the data comparison method and apparatus, the device, and the storage medium according to the embodiments of the present disclosure, after receiving the stock comparison instruction, the stock comparison page is displayed. The stock comparison page includes the menu view and the row views corresponding to the menu view. The menu view includes the stock name column and the data index selection list column. The data index selection list column includes the at least two data indexes, and each of the at least two data indexes includes the at least one index. The row view corresponding to the stock name column includes at least two first bar sub-views, and each of the at least two first bar sub-views is used to display the button for adding the to-be-compared stock or display the name of the to-be-compared stock and the delete button. The row view corresponding to each of the at least one index includes the at least two second bar sub-views, and each of the at least two second bar sub-views is used to display the data of each of the at least one index of each to-be-compared stock. Therefore, the data of a plurality of different indexes of a plurality of stocks can be displayed and compared, so that a relatively comprehensive data comparison can be performed on the stocks, which facilitates a user making an accurate investment choice.

### BRIEF DESCRIPTION OF THE DRAWINGS

FIG. 1 is a schematic diagram illustrating an application scenario of a data comparison method according to an embodiment of the present disclosure;

FIG. 2 is a flowchart of a data comparison method according to an embodiment of the present disclosure;

FIG. 3 is a schematic diagram illustrating a setting position of a stock comparison button according to an embodiment of the present disclosure;

FIG. 4 is a schematic diagram illustrating a setting position of a stock comparison button according to an embodiment of the present disclosure;

FIG. 5 is a schematic diagram illustrating a setting position of a stock comparison button according to an embodiment of the present disclosure;

FIG. 6 is a schematic diagram illustrating a stock comparison page according to an embodiment of the present disclosure;

FIG. 7 is a schematic diagram illustrating a stock comparison page according to an embodiment of the present disclosure;

FIG. 8 is an interactive flowchart of an example of a data comparison method according to an embodiment of the present disclosure;

FIG. 9 is a schematic diagram of entering a stock adding page from a stock comparison page in an example of a data comparison method according to an embodiment of the present disclosure;

FIG. 10 is a schematic diagram illustrating a stock comparison page according to an embodiment of the present disclosure;

FIG. 11 is an interactive flowchart of an example of a data comparison method according to an embodiment of the present disclosure;

FIG. 12 is a schematic diagram illustrating a stock comparison page according to an embodiment of the present disclosure;

FIG. 13 is an interactive flowchart of an example of a data comparison method according to an embodiment of the present disclosure;

FIG. 14 is an interactive flowchart of an example of a data comparison method according to an embodiment of the present disclosure;

FIG. 15 is an interactive flowchart of an example of a data comparison method according to an embodiment of the present disclosure;

FIG. 16 is a flowchart of an example of a data comparison method according to an embodiment of the present disclosure;

FIG. 17 is a schematic diagram illustrating a stock comparison page according to an embodiment of the present disclosure;

FIG. 18 is a schematic structural diagram illustrating a data comparison apparatus according to an embodiment of the present disclosure;

FIG. 19 is a schematic structural diagram illustrating a data comparison apparatus according to an embodiment of the present disclosure; and

FIG. 20 is a schematic structural diagram of an electronic device according to an embodiment of the present disclosure.

### DETAILED DESCRIPTION

The embodiments of the present disclosure will be described in detail below with reference to examples thereof as illustrated in the accompanying drawings. The embodiments described below with reference to the drawings are illustrative only, and are intended to explain, rather than limiting, the present disclosure.

Terms “first” and “second” in the specification and claims of the present disclosure are used to distinguish different objects, rather than to describe a specific sequence. Terms “including” and “having” and any variations thereof in the embodiments of the present disclosure are intended to cover non-exclusive inclusions. For example, a process, method, system, product, or device that includes a series of steps or units is not necessarily limited to those clearly listed steps or units, and may also include other steps or units that are not clearly listed or are inherent to the process, method, product, or device.

Some of terms in the embodiments of the present disclosure will be explained below so as to facilitate the understanding by those skilled in the art.

1. A data index refers to a classification name of different types of stock data. For example, in the embodiment of the present disclosure, the data index includes five categories, i.e., a market index, a valuation index, an analysis index, a financial index, and financial data. Each type of the data index includes a plurality of indexes. For example, the market index includes a yesterday's closing price, a total market value, a circulation market value, a trading volume, a turnover, a 52-week highest, and a 52-week lowest, and the like. The valuation index includes earnings per share, a price-earnings ratio, net assets per share, a price-to-book ratio, a market-to-sales ratio, and a dividend yield TTM, and the like. The analysis index includes an average target price of analysts, a short selling ratio, an institutional shareholding ratio, and an ownership concentration, and the like. The financial index includes ROE, ROA, a gross profit margin, a net interest rate, an asset-liability ratio, a current ratio, a quick ratio, an accounts receivable turnover rate, an accounts payable turnover rate, a fixed assets turnover rate, an inventory turnover rate, a sales expense rate, and an intangible assets ratio, and the like. The financial data include operating income, gross profit, net profit, total assets, total liabilities, operating cash flow, investment cash flow, and financing cash flow, and the like.

2. A chart refers to a graph, a histogram, or a broken line chart

The existing stock comparison function has few data indexes and is not comprehensive enough. To solve this problem, the embodiments of the present disclosure provide a data comparison method and apparatus, a device, and a storage medium. A stock comparison page is set, and includes a menu view and row views corresponding to the menu view. The menu view includes a stock name column and a data index selection list column. The data index selection list column includes at least two data indexes, and each of the at least two data indexes includes at least one index. A row view corresponding to the stock name column includes at least two first bar sub-views, and each of the at least two first bar sub-views is used to display a button for adding a to-be-compared stock or display a name of the to-be-compared stock and a delete button. A row view corresponding to each of the at least one index includes at least two second bar sub-views, and each of the at least two second bar sub-views is used to display data of each of the at least one index of each to-be-compared stock. Therefore, data of a plurality of different indexes of a plurality of stocks can be displayed and compared, so that a relatively comprehensive data comparison can be performed on the stocks, which facilitates a user making an accurate investment choice.

Further, in the data comparison method according to an embodiment of the present disclosure, the stock comparison page further includes a chart showing view for showing a chart corresponding to the data of the index of the to-be-compared stock. The chart may be a graph, a histogram, a broken line chart, or the like. Compared with a number comparison, the comparison of stock data through the chart is more intuitive and can improve user experience.

Further, due to limitation on a size of a screen of an electronic device, the number of the to-be-compared stocks that can be displayed on the stock comparison page is limited, and the user can slide the stock comparison page to data of different indexes of stocks that the user wants to know by side-sliding the screen. However, each stock has data of the plurality of indexes. For one stock, the data of each index corresponds to the second bar sub-view. In the related art, different second bar sub-views will have slight offset during sliding leftwards or rightwards. In financial software industry, even slight offset would have negative influence on user decision-making. To solve this problem, in the data comparison method according to the embodiments of the present disclosure, by monitoring a side-sliding operation on a target bar sub-view (which is one of the second bar sub-views) from the user, a side-sliding direction and a side-sliding distance are determined based on the side-sliding operation. Then, a side-sliding instruction is transmitted to the second bar sub-views expect the target bar sub-view. The side-sliding instruction carries the side-sliding direction and the side-sliding distance and is used for the bar sub-view receiving the side-sliding instruction to slide based on the side-sliding direction and the side-sliding distance. As a result, all the second bar sub-views slide in the same side-sliding direction by the same side-sliding distance, and a synchronous side-sliding of all the second bar sub-views is realized, which can avoid slight offset.

The technical solution according to embodiments of the present disclosure is described in detail with reference to the accompanying drawings.

Next, an application scenario related to the embodiment of the present disclosure is illustrated by example.

The data comparison method according to the embodiments of the present disclosure may be at least applied to the following application scenarios, which will be described with reference to the accompanying drawings.

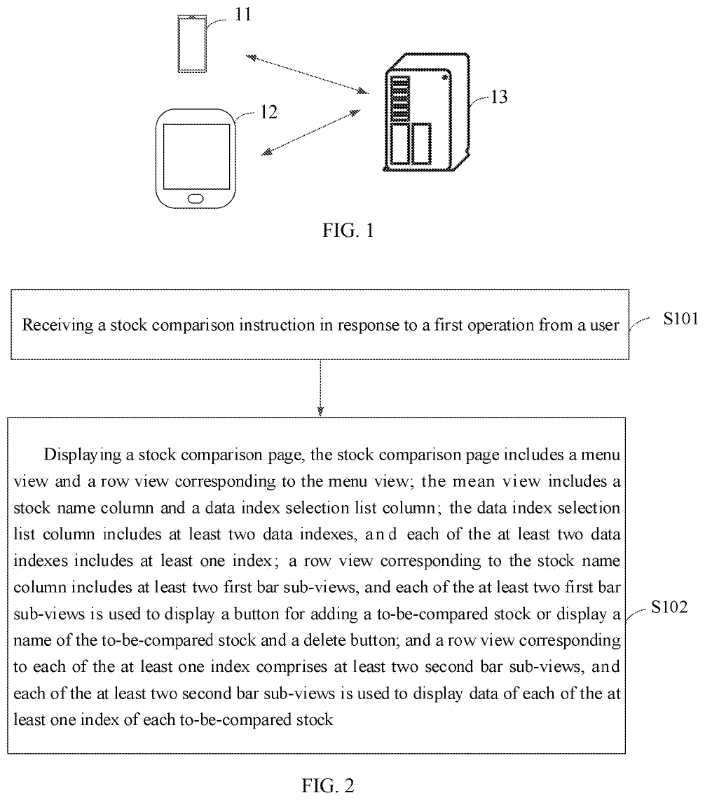

Those skilled in the art should understand that the data comparison method according to the embodiments of the present disclosure may be applicable to a scenario where a user views data of different indexes of different stocks through a stock APP installed on an electronic device for investment or other operations. Exemplarily, FIG. 1 is a schematic diagram of an application scenario of a data comparison method according to an embodiment of the present disclosure. As shown in FIG. 1, the application scenario may include at least one electronic device (two electronic devices including an electronic device 11 and an electronic device 12 are shown in FIG. 1, respectively) and a server 13. Each of the two electronic devices is communicable with the Server 13 through a network. In some embodiments of the present disclosure, the electronic device may be a mobile phone, a personal computer, a tablet computer, or the like.

In some embodiments of the present disclosure, the user may use the electronic device, specifically through the APP (also called a client) installed on the electronic device or a website to view stock information, trade stocks, or other related operations. For example, the stock comparison page is entered from a predetermined page of the stock APP. For example, when the user clicks a stock comparison button displayed on the predetermined page, the client can receive a stock comparison instruction and display the stock comparison page. The server 13 stores names of all stocks and data of each index. In some embodiments of the present disclosure, the server 13 also stores chart data for each index of each stock. When the user selects the to-be-compared stock through the client, a data request carrying the name of the to-be-compared stock (in some embodiments of the present disclosure, the index of the first display chart is also included) is transmitted by the client to the server 13. Upon receiving the data request by the server 13, data information of to-be-compared stock is transmitted to the client. The data information of the to-be-compared stock includes the name of the to-be-compared stock and the data of at least one index of the to-be-compared stock (in some embodiments of the present disclosure, the chart data of the target index of the to-be-compared stock is also included), Then, based on the data information of the to-be-compared stock, by the client, the name of each to-be-compared stock is displayed on each first bar sub-view of the stock display page, and each index data is shown on the second bar sub-view corresponding to each index. In some embodiments of the present disclosure, a chart corresponding to the chart data of the target index is shown on the chart showing view. Therefore, it is possible to make a comprehensive data comparison of stocks and facilitate the user making an accurate investment choice.

The technical solution of the present disclosure and how the technical solution of the present disclosure solves the above technical problem will be described below in detail with specific embodiments. The following specific embodiments may be combined with one another and may not be repeated in some embodiments for identical or similar concepts or processes. Embodiments of the present disclosure will be described below in conjunction with the accompanying drawings.

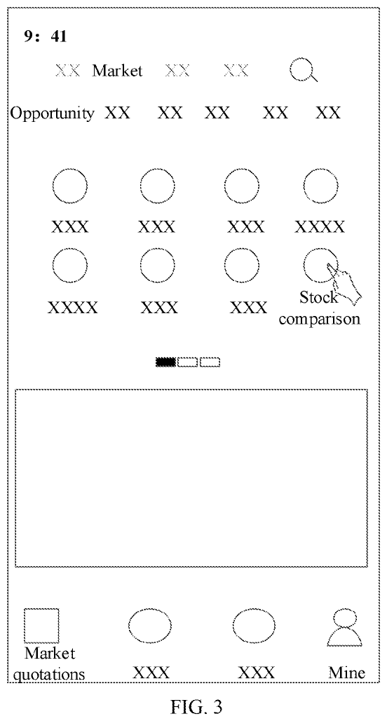

FIG. 2 is a flowchart of a data comparison method according to an embodiment of the present disclosure. The data comparison method may be executed by a data comparison apparatus. The data comparison apparatus may be implemented by means of software and/or hardware, and in some embodiments of the present disclosure, may be performed by the client. As shown in FIG. 2, the method of the present embodiment may include actions at blocks S101 and S102.

At S101, a stock comparison instruction is received in response to a first operation from a user.

In some embodiments of the present disclosure, the first operation may be that a user clicks or touches a stock comparison button or an icon displayed on a predetermined page of a stock APP, and the client receives the stock comparison instruction in response to the first operation.

As an implementation, FIG. 3 is a schematic diagram illustrating a setting position of the stock comparison button according to an embodiment of the present disclosure. As shown in FIG. 3, for example, the stock comparison button or icon (that is, an entrance to a stock comparison function) may be set in a King Kong area under an opportunity key (tab) in a market page in a homepage of the stock APP. The user can click the stock comparison button to enter the stock comparison page. In some embodiments of the present disclosure, the user can set a new identifier before clicking.

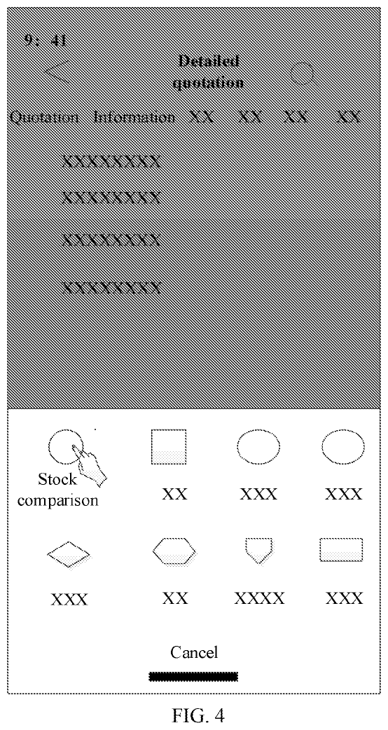

As another implementation, FIG. 4 is a schematic diagram illustrating a setting position of a stock comparison button according to an embodiment of the present disclosure. As shown in FIG. 4, for example, the stock comparison button or icon (that is, the entrance to the stock comparison function) may be set in a bottom functional area under a quote key (tab) in an individual stock page. In some embodiments of the present disclosure, a first function icon may be set, and the user may click the stock comparison button to enter the stock comparison page. In some embodiments of the present disclosure, the user may set a bubble guidance before clicking. For example, the bubble guidance may appear when the user enters the individual stock page for the first time, or other icon prompts may be added, such as a red dot prompt.

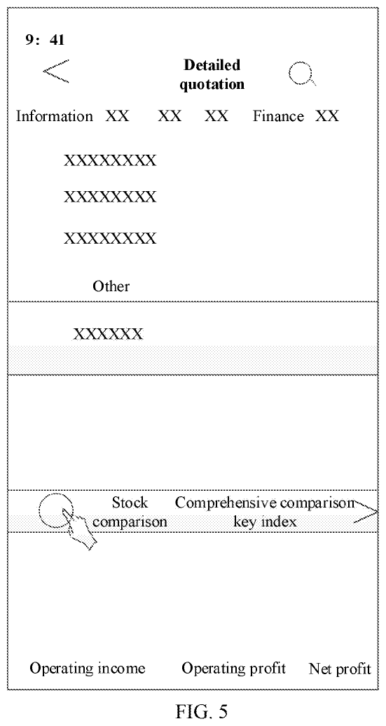

As another implementation, FIG. 5 is a schematic diagram illustrating a setting position of a stock comparison button according to an embodiment of the present disclosure. As shown in FIG. 5, for example, the stock comparison button or icon (i.e., the entrance of the stock comparison function) may be set under a financial key (tab) in the individual stock page. In particular, the stock comparison button or icon may be set as a scenario-based strip-shaped entrance. The user can click the stock comparison button to enter the stock comparison page.

It should be noted that the above position of the stock comparison button and the setting of the icon are merely examples, other icons may be set, and a predetermined position on other pages may be set, which does not constitute a limitation on the embodiments of the present disclosure.

At S102, a stock comparison page is displayed. The stock comparison page includes a menu view and row views corresponding to the menu view. The menu view includes a stock name column and a data index selection list column. The data index selection list column includes at least two data indexes, and each of the at least two data indexes includes at least one index. A row view corresponding to the stock name column includes at least two first bar sub-views, and each of the at least two first bar sub-views is used to display a button for adding a to-be-compared stock or display a name of the to-be-compared stock and a delete button. A row view corresponding to each of the at least one index includes at least two second bar sub-views, and each of the at least two second bar sub-views is used to display data of each of the at least one index of each to-be-compared stock.

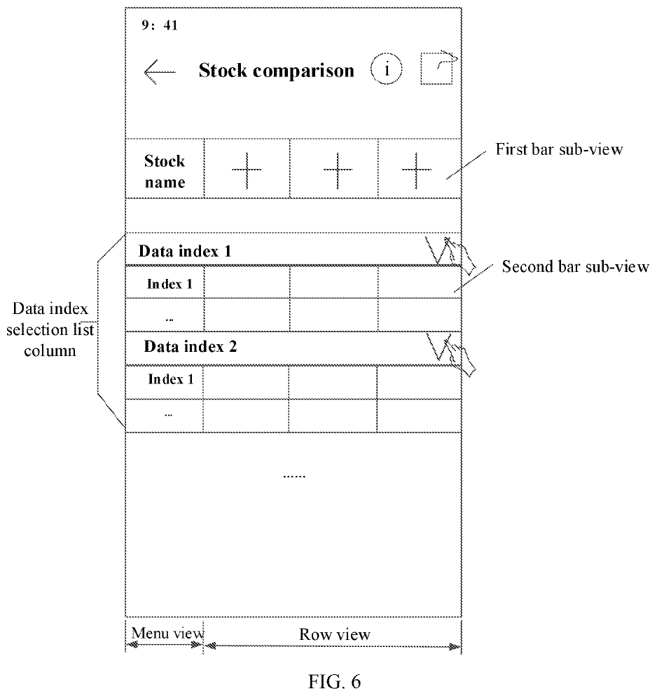

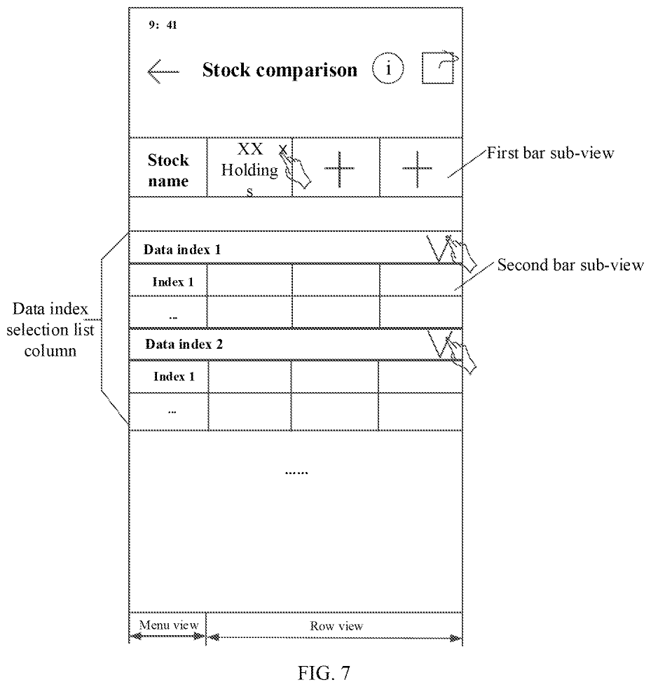

By way of example, FIG. 6 is a schematic diagram illustrating a stock comparison page according to an embodiment of the present disclosure. The data index selection list column includes at least two data indexes (a data index 1 and a data index 2 as shown in FIG. 6). Each data index includes at least one index (the index 1 and the index 2 as shown in FIG. 6). The user may click the icon indicated by the gesture in FIG. 6 to expand and fold each data index. An expanded state is illustrated in FIG. 6. The row view corresponding to the stock name column includes at least two first bar sub-views. As shown in FIG. 6, the current stock comparison page may display three first bar sub-views. In this embodiment, the row view corresponding to the stock name column may include at least six first bar sub-views. That is, the user may select and add at least six stocks once to compare various index data of these stocks. The row view corresponding to each index includes at least two second bar sub-views. Each second bar sub-view is used to display the data of each index of each to-be-compared stock. As shown in FIG. 6, the current stock comparison page may display three second bar sub-views. It should be understood that the number of second bar sub-views is the same as the number of the first bar sub-view. Each first bar sub-view is used to display the button for adding the to-be-compared stock (“+” shown in FIG. 6), and the user can click the button “+” to enter the page for adding the to-be-compared stock and select the to-be-compared stock. When the to-be-compared stock is pre-stored or the to-be-compared stock is added by the user, each first bar sub-view can display the name of the to-be-compared stock and the delete button. FIG. 7 is a schematic diagram illustrating a stock comparison page according to an embodiment of the present disclosure. As shown in FIG. 7, if the to-be-compared stock selected by the user is “XX Holdings”, the first bar sub-view displays “XX Holdings” and the delete button “x”.

According to the data comparison method according to the embodiments of the present disclosure, after receiving the stock comparison instruction, the stock comparison page is displayed. The stock comparison page includes a menu view and row views corresponding to the menu view. The menu view includes a stock name column and a data index selection list column. The data index selection list column includes at least two data indexes, and each of the at least two data indexes includes at least one index. A row view corresponding to the stock name column includes at least two first bar sub-views, and each of the at least two first bar sub-views is used to display a button for adding a to-be-compared stock or display a name of the to-be-compared stock and a delete button. A row view corresponding to each of the at least one index includes at least two second bar sub-views, and each of the at least two second bar sub-views is used to display data of each of the at least one index of each to-be-compared stock. Therefore, the data of a plurality of different indexes of a plurality of stocks can be displayed and compared, so that a relatively comprehensive data comparison can be performed on the stocks, which facilitates the user making an accurate investment choice.

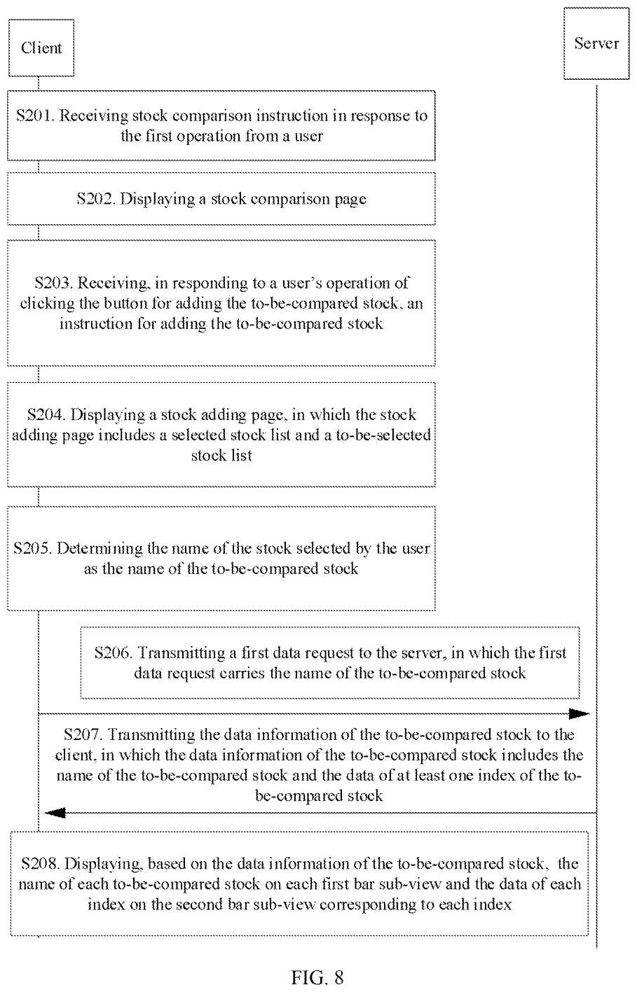

In an embodiment of that present disclosure, when the user enters the stock comparison page for the first time, the page shown in FIG. 6 can be displayed. That is, the row view corresponding to the stock name column has no to-be-compared stock, and the user needs to select and add the to-be-compared stock. In this case, FIG. 8 is an interactive flowchart of an embodiment of a data comparison method according to an embodiment of the present disclosure. As shown in FIG. 8, the method of the embodiment may include actions at blocks S201 to S204.

At S201, the stock comparison instruction is received by the client in response to the first operation from the user.

At S202, the stock comparison page is displayed by the client.

The stock comparison page includes a menu view and row views corresponding to the menu view. The menu view includes a stock name column and a data index selection list column. The data index selection list column includes at least two data indexes, and each of the at least two data indexes includes at least one index. A row view corresponding to the stock name column includes at least two first bar sub-views, and each of the at least two first bar sub-views is used to display a button for adding a to-be-compared stock or display a name of the to-be-compared stock and a delete button. A row view corresponding to each of the at least one index includes at least two second bar sub-views, and each of the at least two second bar sub-views is used to display data of each of the at least one index of each to-be-compared stock.

At S203, an instruction for adding the to-be-compared stock is received by the client in responding to an operation in which the button for adding the to-be-compared stock is clicked by the user.

At S204, a stock adding page is displayed by the client. The stock adding page includes a selected stock list and a to-be-selected stock list. The to-be-selected stock list includes names of a plurality of stocks to be selected by the user.

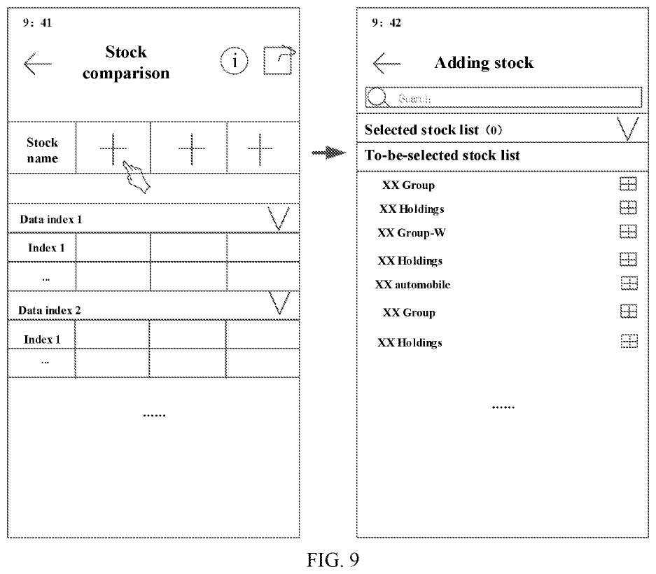

FIG. 9 is a schematic diagram of entering a stock adding page from a stock comparison page in an embodiment of a data comparison method according to an embodiment of the present disclosure. As shown in FIG. 9, the user clicks the button for adding the to-be-compared stock (i.e., “+” as shown in FIG. 9), the client receives the button for adding the to-be-compared stock, then the client displays the stock adding page. As shown in FIG. 9, the stock adding page includes the selected stock list and the to-be-selected stock list, in which the selected stock list is folded by default. In some embodiments of the present disclosure, the to-be-selected stock list may display the top five market capitalization stocks of a same industry and stocks selected by users. In some embodiments of the present disclosure, the stock adding function can reuse the interaction of adding stocks in the existing portfolio function.

In some embodiments of the present disclosure, the method further includes, prior to displaying the stock adding page: determining a stock recommended to the user and displaying stock recommended to the user in the to-be-selected stock list. In some embodiments of the present disclosure, the method of the embodiment may further include, prior to S204: determining a to-be-recommended stock based on a predetermined index and/or stock attribute information of a stock in the selected stock list; and determining the to-be-recommended stock as the to-be-selected stock in the to-be-selected stock list. A display priority of the to-be-recommended stock is higher than display priorities of other to-be-selected stocks.

In some embodiments of the present disclosure, the predetermined index may be one or more or all of the indexes, and the stock attribute information may include an industry to which the stock belongs and/or the company market value of the stock, and the like. When determining the to-be-recommended stock based on the stock attribute information of the stock in the selected stock list, for example, the stock attribute information may include the industry to which the stock belongs and the company market value of the stock, in an implementation, for example, a stock in a same industry as the stock in the selected stock list and ranked in the top 5 in the company market value is determined as the to-be-recommended stock. When there is a plurality of predetermined indexes, the to-be-recommended stock is determined based on the predetermined indexes of stocks in the selected stock list. In particular, a stock of which a difference between a weighted average of the plurality of predetermined indexes of the stock and a weighted average of the plurality of predetermined indexes of the stock in the selected stock list is smaller than or equal to a predetermined threshold is determined as the to-be-recommended stock. The determining the to-be-recommended stock based on the predetermined index and the stock attribute information of the stock in the selected stock list, in an implementation, for example, further includes, first determining the to-be-recommended stock based on the stock attribute information of the stock in the selected stock list, and then determining the stock, of which the difference between the weighted average of the plurality of predetermined indexes of the stock and the weighted average of the plurality of predetermined indexes of the stock in the selected stock list is smaller than or equal to a predetermined threshold, as the to-be-recommended stock. In the method, the determined to-be-recommended stock and the stock in the selected stock list are more comparable for the user, and the user experience can be further improved.

In some embodiments of the present disclosure, the determining the to-be-recommended stock based on the predetermined index and/or the stock attribute information of the stock in the selected stock list may include the following actions at step 1 to step 3.

At step 1: an index parameter corresponding to each predetermined index of the stock in the selected stock list is calculated based on the plurality of predetermined indexes and stock attribute information of the stock in the selected stock list.

At step 2: a weighted expected value is determined based on the index parameter of each predetermined index.

At step 3: a stock corresponding to a target weighted expected value is determined as the to-be-recommended stock.

In some embodiments of the present disclosure, the plurality of predetermined indexes includes at least one of indexes predetermined by the user and including an attention index corresponding to a target attention stock determined by the user, an industry index corresponding to a trading industry, a shareholder index in stock information, a market value index corresponding to a stock issuing subject, a price-earnings ratio index, and the like.

At step 1, an index parameter may be determined by calculating a similarity between each stock attribute information and each predetermined index. For example, an industry index parameter between the industry index corresponding to the trading industry determined by the user and the industry information in the stock attribute information of the current stock is calculated by the following equation:

$${t}_{1} = \frac{\sqrt{{( {m}_{1} - {n}_{1} )}^{2} + {( {m}_{2} - {n}_{2} )}^{2} + … + {( {m}_{i} - {n}_{i} )}^{2}}}{\sqrt{{\sum }_{k = 1}^{i} {m}_{i}^{2}} \cdot \sqrt{{\sum }_{k = 1}^{i} {n}_{i}^{2}}} ,$$

where m₁˜mᵢ constitutes a character string corresponding to the industry index corresponding to the trading industry determined by the user, n₁˜nᵢ constitutes a character string corresponding to the industry index corresponding to the industry information in the stock attribute information of the current stock, and i represents the number of characters in the character string. The index parameter may also be determined by calculating a difference ratio. For example, a market value index parameter between a market value index determined by the user and market value information in the stock attribute information of the current stock is calculated by the following equation:

t₂=(h−g)/g,

where h represents the market value index determined by the user, and g represents the market value information in the stock attribute information of the current stock. Therefore, corresponding values t₁, t₂, . . . tᵢ₋₁, tᵢ of each index parameter are obtained.

At step 2, the weighted expected value is calculated based on the index parameter of each predetermined index by the following equation:

Wei=α₁t₁+α₂t₂+ . . . +αᵢ₋₁tᵢ₋₁+αtᵢ,

where Wei represents the weighted expected value determined based on the index parameter of each predetermined index, and α₁ [symbol] α₂ [symbol] . . . [symbol] αᵢ₋₁ [symbol] αᵢ represent the corresponding determined weight of each index parameter.

At step 3, a target weighted expected value with a higher value may be determined based on the number of the to-be-recommended stocks, and then the stock corresponding to the target weighted expected value is selected as the to-be-recommended stock. In the embodiment, the stock is recommended in the above manner, and the weighted expected value corresponding to each stock is calculated based on the information determined by the user. Thus, the stock more suitable for the user requirements can be obtained, and the success rate of stock recommendation can be improved.

At S205, the name of the stock selected by the user is determined by the client as the name of the to-be-compared stock.

In some embodiments of the present disclosure, the name of the stock selected by the user through the stock adding page is determined as the name of the to-be-compared stock.

At S206, a first data request is transmitted to a server by the client. The first data request carries the name of the to-be-compared stock.

In some embodiments of the present disclosure, the first data request carries the name of the to-be-compared stock determined at S205.

At S207, the data information of the to-be-compared stock is transmitted to the client by the server. The data information of the to-be-compared stock includes the name of the to-be-compared stock and the data of at least one index of the to-be-compared stock.

At S208, based on the data information of the to-be-compared stock, by the client, the name of each to-be-compared stock is displayed on each first bar sub-view, and the data of each index is displayed on the second bar sub-view corresponding to each index.

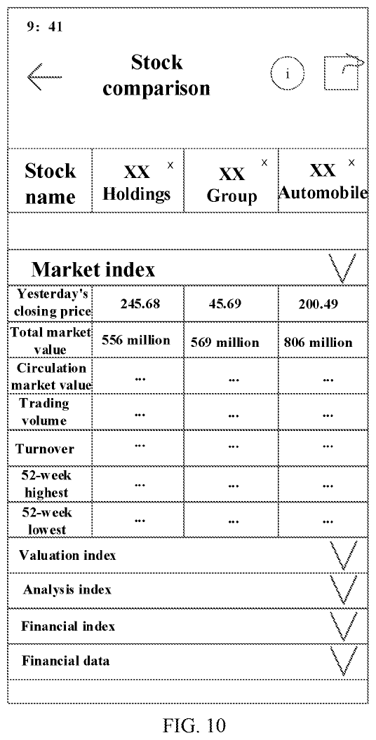

FIG. 10 is a schematic diagram illustrating a stock comparison page according to an embodiment of the present disclosure. As shown in FIG. 10, in this embodiment, the names of the to-be-compared stock carried by the first data request are “XX Holdings”, “XX Group”, and “XX Automobile”. The data index, for example, includes a market index, a valuation index, an analysis index, a financial index, and financial data. The market index, for example, includes a yesterday's closing price, a total market value, a circulation market value, a trading volume, a turnover, a 52-week highest, and a 52-week lowest. For example, the valuation index, the analysis index, the financial index, and the financial data are all not shown in FIG. 10, and the currency is, for example, RMB by default.

According to the data comparison method according to the embodiment of the present disclosure, the data of a plurality of different indexes of a plurality of stocks can be displayed, and the comparison of the data of a plurality of different indexes can be achieved, thereby more comprehensive data comparison can be performed on the stocks, which facilitates the user making accurate investment choices.

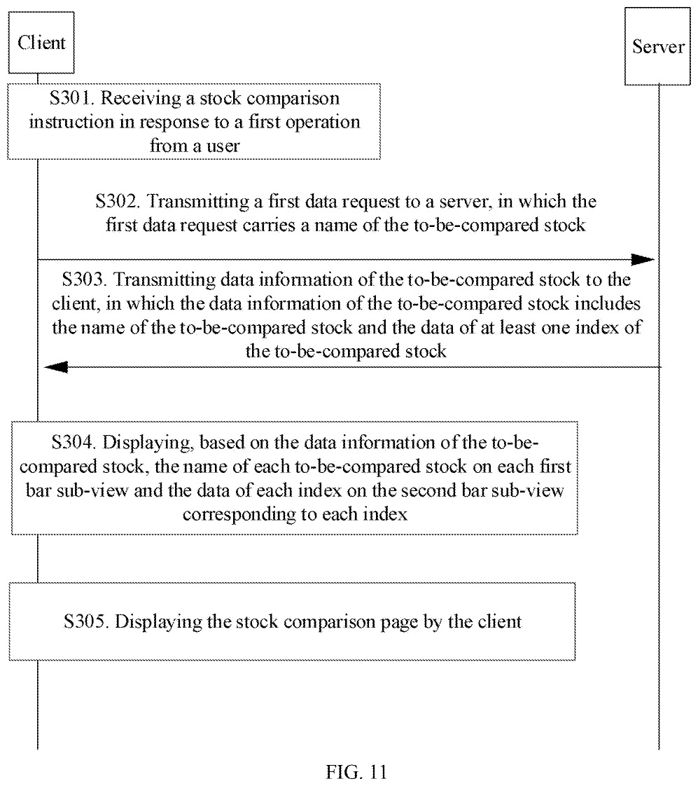

In some embodiments of the present disclosure, when the user enters the stock comparison page for the first time, the page shown in FIG. 10 can also be displayed. That is, the name of the to-be-compared stock already exists in the stock name column, and corresponding data is displayed on each third bar sub-view. In this case, the name of the to-be-compared stock includes a name of a pre-stored stock or a stock last selected by the user, and the name of the to-be-compared stock selected each time by the user will be recorded by the server, and transmitted to the client in response to the request from the client. FIG. 11 is an interactive flowchart of an embodiment of a data comparison method according to an embodiment of the present disclosure. As shown in FIG. 11, the method of the embodiment may include actions at block S301 to S305.

At S301, a stock comparison instruction is received by a client in response to a first operation from a user.

At S302, a first data request is transmitted to a server by the client. The first data request carries a name of the to-be-compared stock.

In some embodiments of the present disclosure, the name of the to-be-compared stock includes a name of a pre-stored stock or a stock last selected by the user.

At S303, data information of the to-be-compared stock is transmitted to the client by the server. The data information of the to-be-compared stock includes the name of the to-be-compared stock and the data of at least one index of the to-be-compared stock.

At S304, based on the data information of the to-be-compared stock, by the client, the name of each to-be-compared stock is displayed on each first bar sub-view, and the data of each index is displayed on the second bar sub-view corresponding to each index.

At S305, the stock comparison page is displayed by the client.

The stock comparison page includes a menu view and row views corresponding to the menu view. The menu view includes a stock name column and a data index selection list column. The data index selection list column includes at least two data indexes, and each of the at least two data indexes includes at least one index. A row view corresponding to the stock name column includes at least two first bar sub-views, and each of the at least two first bar sub-views is used to display a button for adding a to-be-compared stock or display a name of the to-be-compared stock and a delete button. A row view corresponding to each of the at least one index includes at least two second bar sub-views, and each of the at least two second bar sub-views is used to display data of each of the at least one index of each to-be-compared stock.

In the data comparison method according to the embodiments of the present disclosure, it is possible to display the data of a plurality of different indexes of a plurality of stocks and perform the data comparison on a plurality of different indexes, thereby performing more comprehensive data comparison on the stocks, which facilitates the user making accurate investment choices.

In the above embodiment, when the first operation is performed on a first page, the name of the to-be-compared stock includes a name of a pre-stored stock or a name of a stock selected by the user last time. For example, when the user performs the first operation from the market page shown in FIG. 3, the user enters the market page for the first time, and the name of the to-be-compared stock is the name of the pre-stored stock. When the user enters the market page for the first operation next time, the name of the to-be-compared stock is the name of the stock selected by the user last time, and the data of all indexes of the to-be-compared stock selected by the user last time can be directly displayed.

When the first operation is performed on a second page, the name of the to-be-compared stock includes a name of a current stock on the second page and a name of a stock selected by the user, or includes the name of the stock selected by the user last time. For example, when the user performs the first operation on the individual stock page shown in FIG. 4, if the user enters the individual stock page for the first time, one of the names of the to-be-compared stocks is the name of the current stock on the individual stock page, and other to-be-compared stocks need to be added by the user. When the user enters the individual stock page for the first operation next time, the name of the to-be-compared stock is the name of the stock selected by the user last time, and the data of all indexes of the to-be-compared stock selected by the user last time can be directly displayed.

Further, the method according to the embodiment may further include the following prior to transmitting the first data request to the server by the client at S302.

In response to determining that the first operation is performed on the second page, the name of the current stock on the second page is determined as the name of the to-be-compared stock.

In response to the first operation is performed on a page except the second page, the button for adding the to-be-compared stock is displayed on the first bar sub-view.

For example, the second page is the individual stock page shown in FIG. 4. In response to determining that the first operation is performed on the individual stock page, the name of the current stock on the individual stock page is determined as the name of the to-be-compared stock. In response to determining that the first operation is not performed on the individual stock page, the button for adding the to-be-compared stock is displayed on each first bar sub-view for the user to select and add the to-be-compared stock.

Further, in the data comparison method according to the embodiment of the present disclosure, the stock comparison page also includes a chart showing view used to show a chart corresponding to the data of each index of each to-be-compared stock. The chart may be a graph, a histogram, a broken line chart, or the like. For example, if six stocks are compared once, the chart is set with six different colors, and each color corresponds to a chart of one stock.

In some embodiments of the present disclosure, the menu view may also include a currency selection column, and a row view corresponding to the currency selection column includes at least one third bar sub-view used for the user to switch different currencies and is convenient for the user to use. Different indexes of each stock may have different currencies, and the server will uniformly convert the currencies of all data indexes into quotation currencies. If the quotation currencies of the current stock are non-mainstream currencies (such as US dollars, Hong Kong dollars, RMB, and Singapore dollars), the server will convert the quotation currencies into corresponding mainstream currencies based on the stock market. In some embodiments of the present disclosure, the currency corresponding to the first stock for the first time is shown on the stock comparison page by the client, and the user can uniformly switch the currencies of all comparison stocks. For example, the currency switching can support the switching of US dollars, Hong Kong dollars, RMB, and Singapore dollars.

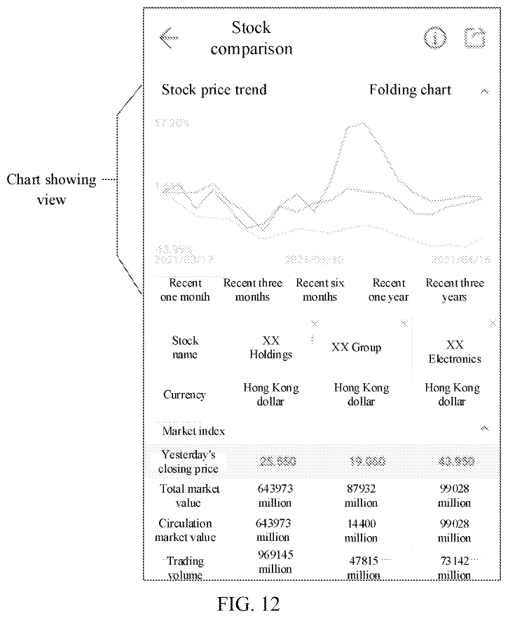

In some embodiments of the present disclosure, in the stock comparison page shown for the first time, a chart corresponding to the data of the first index in the first data index shown for the first time is set. For example, the first index in the first data index is a yesterday's closing price. FIG. 12 is a schematic diagram of a stock comparison page according to an embodiment of the present disclosure. As shown in FIG. 12, the chart showing view shows the chart corresponding to the data of the yesterday's closing price, which is a graph corresponding to the stock price trend and may include the stock price trend in recent one month, three months, six months, one year, and three years. Three curves correspond to the stock price trend of three stocks respectively, and the chart can be expanded or folded. Compared with the number comparison, the comparison of stock data through charts is more intuitive and can improve the user experience.

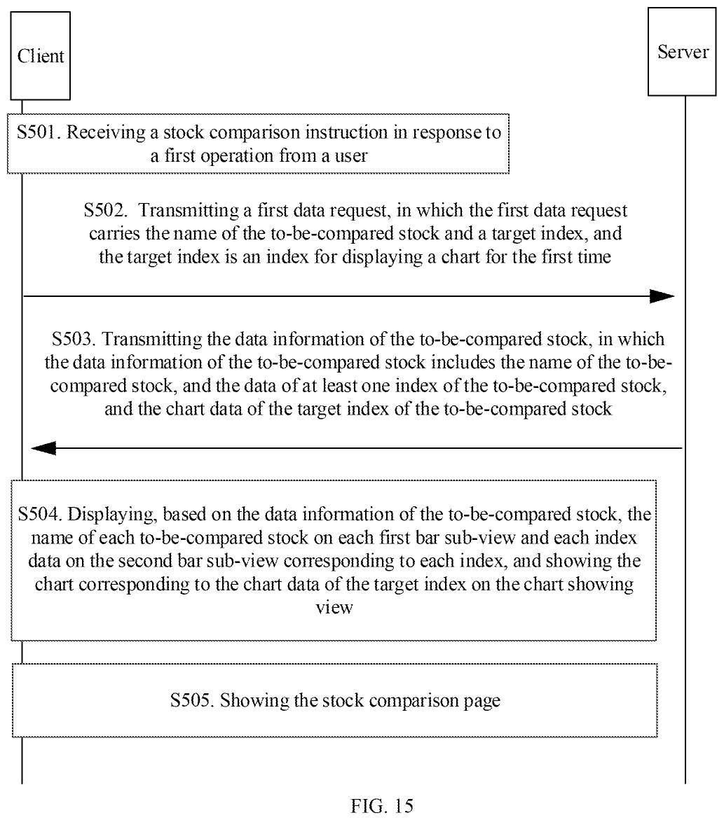

The following details the implementation of the stock comparison page, which also includes a chart showing view, in conjunction with FIG. 0.13 to FIG. 15.

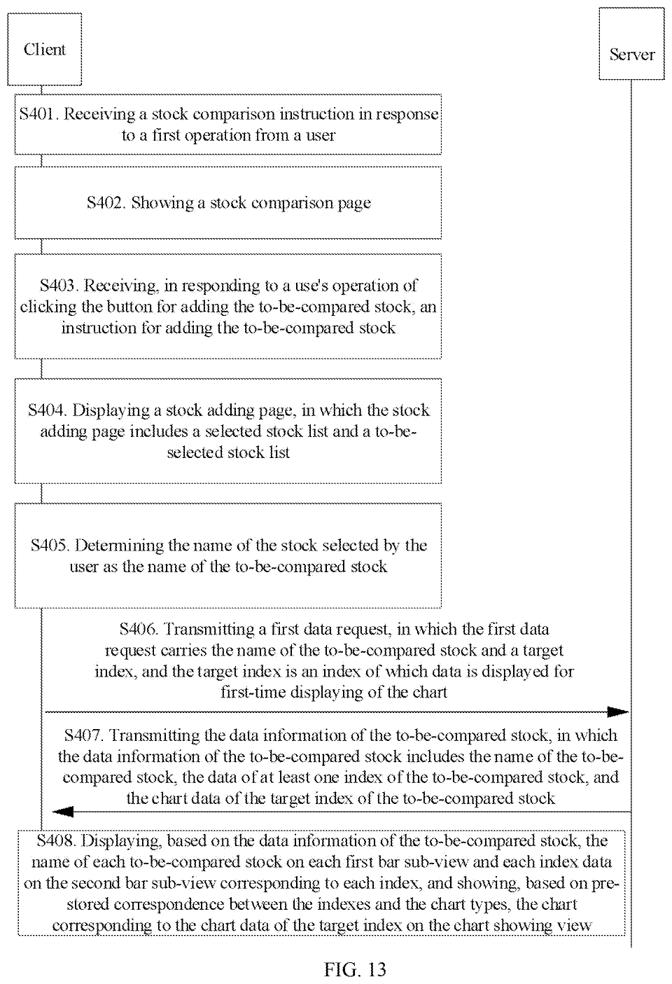

FIG. 13 is an interactive flowchart of an embodiment of a data comparison method according to an embodiment of the present disclosure. In the embodiment, when a user enters a stock comparison page for a first time, there is no to-be-compared stock in a row view corresponding to a stock name column, and the user needs to select and add the to-be-compared stock. As shown in FIG. 13, the method of the embodiment may include actions at S401 to S408.

At S401, a stock comparison instruction is received by a client in response to a first operation from a user.

At S402, the stock comparison page is shown by the client.

The stock comparison page includes a chart showing view, a menu view, and row views corresponding to the menu view. The chart showing view is used to show a chart corresponding to the data of each index of each to-be-compared stock. The menu view includes a stock name column and a data index selection list column. The data index selection list column includes at least two data indexes, and each of the at least two data indexes includes at least one index. The row view corresponding to the stock name column includes at least two first bar sub-views, and each of the at least two first bar sub-views is used to display the button for adding the to-be-compared stock or display the name of the to-be-compared stock and the delete button. The row view corresponding to each of the at least one index includes at least two second bar sub-views, and each of the at least two second bar sub-views is used to display data of each index.

At S403, an instruction for adding the to-be-compared stock is received by the client in responding to an operation in which the button for adding the to-be-compared stock is clicked by the user.

At S404, a stock adding page is displayed by the client. The stock adding page includes a selected stock list and a to-be-selected stock list.

This embodiment is the same as the embodiment shown in FIG. 8, except that the stock comparison page also includes the chart showing view, and thus the description thereof in detail will be omitted herein.

At S405, the name of the stock selected by the user is determined as the name of the to-be-compared stock by the client.

In some embodiments of the present disclosure, the name of the stock selected by the user through the stock adding page is determined as the name of the to-be-compared stock.

At S406, a first data request is transmitted to a server by the client. The first data request carries the name of the to-be-compared stock and a target index, and the target index is an index of which data is displayed for first-time displaying of the chart.

In some embodiments of the present disclosure, the first data request carries the name of the to-be-compared stock determined at S405, and the target index may be a predetermined index, for example, the first index of the first data index.

At S407, the data information of the to-be-compared stock is transmitted to the client by the server. The data information of the to-be-compared stock includes the name of the to-be-compared stock, the data of at least one index of the to-be-compared stock, and the chart data of the target index of the to-be-compared stock.

At S408, based on the data information of the to-be-compared stock, by the client, the name of each to-be-compared stock is displayed on each first bar sub-view, and each index data is displayed on the second bar sub-view corresponding to each index. Further, the chart corresponding to the chart data of the target index is shown on the chart showing view based on pre-stored correspondence between the indexes and the chart types.

As an implementation, the showing the chart corresponding to the chart data of the target index on the chart showing view based on the pre-stored correspondence between the indexes and the chart types at S408 includes actions at steps S4081 to S4083.

At S4081, the chart type corresponding to the target index is determined based on the pre-stored correspondence between the indexes and the chart types.

In some embodiments of the present disclosure, the chart may be any one of a graph, a histogram, or a broken line chart. Different indexes correspond to different chart types. First, based on the pre-stored correspondence between the indexes and the chart types, it is determined whether the chart corresponding to the target index is the graph, the broken line chart, or the histogram.

As an implementation, the chart type includes the graph and the histogram. A chart of an index related to historical data is the graph, and a chart of an index unrelated to historical data is the histogram.

At S4082, the chart data of the target index is converted based on the chart type corresponding to the target index, to obtain the converted chart data of the target index.

In some embodiments of the present disclosure, for example, if the chart corresponding to the target index is the graph, the chart data of the target index is converted into chart data corresponding to the graph.

At S4083, the chart corresponding to the converted chart data of the target index is showed on the chart showing view.

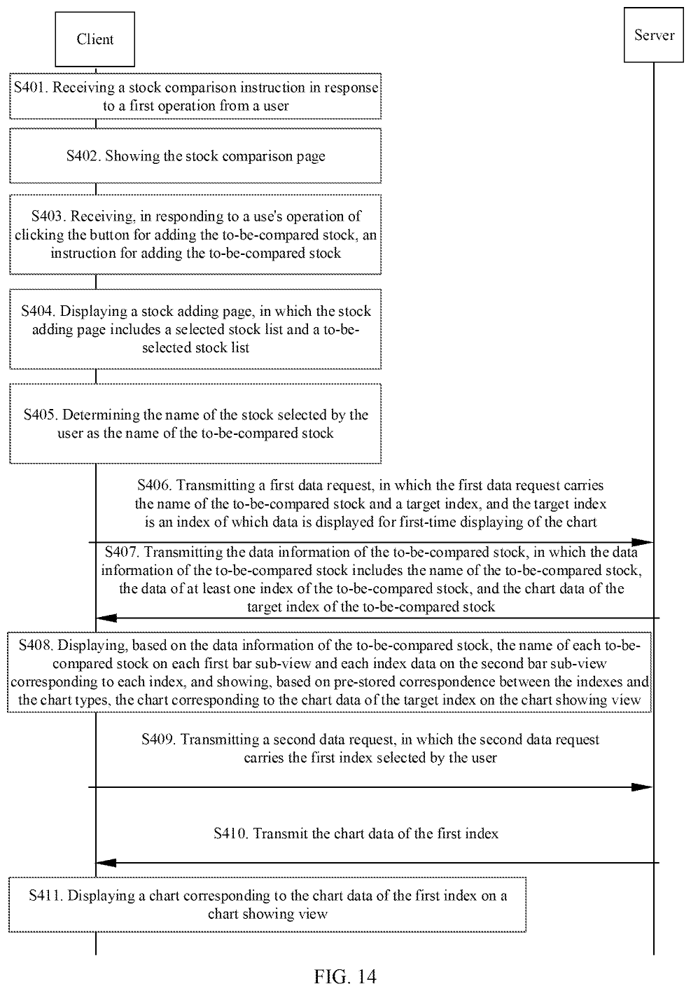

In some embodiments of the present disclosure, after the chart showing view shows the chart corresponding to the chart data of the target index, the user may also switch different indexes to view corresponding charts. In some embodiments of the present disclosure, the user may click on an expanded chart of each data index, and then click on a certain index in the data index. Accordingly, the client requests the chart data of the index from the server, and shows the chart corresponding to the chart data of the index on the chart showing view based on the chart data of the index, which will be explained with reference to FIG. 14 below.

FIG. 14 is an interactive flowchart of an embodiment of a data comparison method according to an embodiment of the present disclosure. As shown in FIG. 14, the method according to the embodiments of the present disclosure further includes actions at S409 to S411.

At S409, a second data request is transmitted to the server by the client. The second data request carries the first index selected by the user.

At S410, the chart data of the first index is transmitted to the client by the server.

At S411, a chart corresponding to the chart data of the first index is shown on a chart showing view.

In some embodiments of the present disclosure, the chart may be any one of the graph, the histogram, or the broken line chart. The chart supports an expanded state or a folded state, and the default state is the expanded state. The user operation is recorded in the APP life cycle, and may also be recorded in the APP life cycle after switching indexes. In some embodiments of the present disclosure, when the page is slid downwards, the whole chart area will be capped, and when the chart is folded, the top operation column will be capped. In some embodiments of the present disclosure, the chart area can occupy about ⅓ area of the stock comparison page.

As an implementation, the chart of index related to historical data adopts the graph, and the graph supports period switching. The periods of different indexes are different. For example, it is determined that the periods are smaller than or equal to 5. After the user switches the period, the curves drawn by historical data in the switched period is shown by the client. In some embodiments of the present disclosure, for the graph, Y axis is shown on a left side of the graph, which is a range of the index data, and the general specification of the graph is used for upper and lower extremes, such as a partial blank. Three pieces of data are shown on the Y axis, and three dates are shown on the X axis. It should be noted that the above is only an example and does not constitute a limitation on the graph.

As an implementation, the chart of index related to no historical data adopts the histogram, which maps the latest data of each comparative stock as the histogram. In some embodiments of the present disclosure, the histogram does not show the Y axis and X axis, the data may be marked above the column, and only 0 line and bottom line are kept as the dividing lines in the histogram.

In the data comparison method according to the embodiment shown in FIG. 13 and FIG. 14, the data of a plurality of different indexes of a plurality of stocks can be displayed, and compared, so that the data comparison of stocks can be performed comprehensively, and thus the user can make accurate investment choices. Moreover, the comparison of stock data through the chart is more intuitive and can improve the user experience.

In some embodiments of the present disclosure, when the user enters the stock comparison page for the first time, the name of the to-be-compared stock already exists in the stock name column, corresponding data is displayed on each third bar sub-view, and the chart showing view also displays charts. In this case, the name of the to-be-compared stock includes a name of a pre-stored stoke or a name of a stock selected by a user last time, and the target index is a predetermined index. The name of the to-be-compared stock selected by the user every time will be recorded by the server, and transmitted to the client in response to the request from the client, which will be described in detail with reference to FIG. 15 below. FIG. 15 is an interactive flowchart of an embodiment of a data comparison method according to an embodiment of the present disclosure. As shown in FIG. 15, the method of the embodiment may include actions at S501 to S505.

At S501, a stock comparison instruction is received by the client in response to a first operation from a user.

At S502, a first data request is transmitted to a server by the client. The first data request carries the name of the to-be-compared stock and a target index, and the target index is the index for displaying a chart for the first time.

In some embodiments of the present disclosure, the name of the to-be-compared stock includes a name of a pre-stored stock or a name of a stock selected by a user last time, and the target index is a predetermined index.

At S503, the data information of the to-be-compared stock is transmitted to the client by the server. The data information of the to-be-compared stock includes the name of the to-be-compared stock, the data of at least one index of the to-be-compared stock, and the chart data of the target index of the to-be-compared stock.

At S504, based on the data information of the to-be-compared stock, by the client, the name of each to-be-compared stock is displayed on each first bar sub-view, each index data is displayed on the second bar sub-view corresponding to each index, and the chart corresponding to the chart data of the target index is shown on the chart showing view.

At S505, the stock comparison page is shown by the client.

The stock comparison page includes a chart showing view, a menu view, and a row view corresponding to the menu view. The chart showing view is used to display a chart corresponding to the data of each index of each to-be-compared stock. The menu view includes a stock name column and a data index selection list column. The data index selection list column includes at least two data indexes, and each of the at least two data indexes includes at least one index. A row view corresponding to the stock name column includes at least two first bar sub-views, and each of the at least two first bar sub-views is used to display the button for adding the to-be-compared stock or display the name of the to-be-compared stock and the delete button. The row view corresponding to each of the at least one index includes at least two second bar sub-views, and each of the at least two second bar sub-views is used to display data of each index.

In the data comparison method according to the embodiments of the present disclosure, the data of a plurality of different indexes of a plurality of stocks can be displayed and compared, so that the data comparison of the stocks can be performed comprehensively, and thus the user can make accurate investment choices. Moreover, the comparison of the stock data through the chart is more intuitive and can improve the user experience.

In the above embodiment, when the first operation is performed on the first page, the name of the to-be-compared stock includes a name of a pre-stored stock or a name of a stock selected by the user last time, and the target index is a predetermined index. For example, the target index may be the first index in the first data index. For example, when the user performs the first operation on the market page shown in FIG. 3, if the user enters the market page for the first time, the name of the to-be-compared stock is the name of the pre-stored stock, and the target index is the predetermined index. When the user enters the market page for the first operation next time, the name of the to-be-compared stock is the name of the stock selected by the user last time, and the data of all indexes of the to-be-compared stock selected by the user last time and the chart of predetermined index can be directly displayed.

When the first operation is performed on the second page, the name of the to-be-compared stock includes the name of the current stock on the second page and the name of the stock selected by the user, or includes the index selected by the user last time, and the target index is a predetermined index. For example, when the user performs the first operation on the individual stock page shown in FIG. 4, if the user enters the individual stock page for the first time, one of the names of the to-be-compared stocks is the name of the current stock on the individual stock page, and other to-be-compared stocks need to be added by the user. When the user enters the individual stock page for the first operation next time, the name of the to-be-compared stock is the name of the stock selected by the user last time, and the data of all indexes of the to-be-compared stock selected by the user last time and the chart of predetermined indexes can be directly displayed.

In some embodiments of the present disclosure, when displaying the chart corresponding to the data of each index of each to-be-compared stock, corresponding data points can be selected based on a display period selected by the user, which is based on the consideration of accuracy. For example, 20 data points are displayed when the display period is 1 month, 60 data points are displayed when the display period is 3 months, 120 data points are displayed when the display period is 6 months, 250 data points are displayed when the display period is 1 year, and 750 data points are displayed when the display period is 3 years.

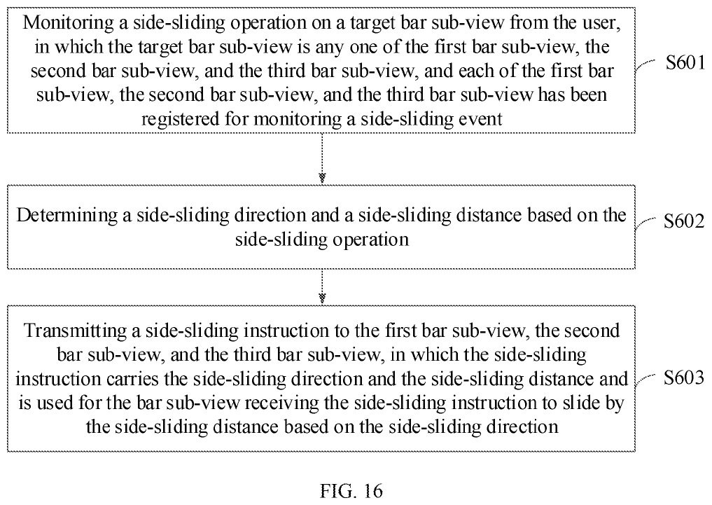

Further, in the stock comparison page in the above embodiment, a layout of the entire page is in a top-and-down direction, the synchronization sliding in the up-and-down direction is automatic. Since the layout is in the top-and-down direction, the row view of each row is independent from each other. Due to the large amount of data that needs to be displayed when comparing the stock data, one page on a screen of an electronic device cannot cover all the comparison data when displaying the comparison data. In order to achieve the synchronization sliding in the up-and-down direction, the row view of each row of a same type at the client is set to be reusable, and the first bar sub-view and the second bar sub-view of the row view are also reusable to achieve a side-sliding. Since the row views are independent from each other and the embedded first and second bar sub-views are also reusable, how to ensure that each first bar sub-view and each second bar sub-view can side-slide synchronously during the side-sliding is another problem to be solved by the embodiment of the present disclosure. To solve this problem, the technical solution according to an embodiment of the present disclosure will be described in detail with reference to FIG. 16.

FIG. 16 is a flowchart of an embodiment of a data comparison method according to an embodiment of the present disclosure. The data comparison method may be executed by a data comparison apparatus, which may be implemented by means of software and/or hardware. In some embodiments of the present disclosure, the data comparison method may be performed by a client. As shown in FIG. 16, the method according to the present embodiment may include actions at S601 to S S603.

At S601, a side-sliding operation on a target bar sub-view from the user is monitored. The target bar sub-view is any one of the first bar sub-view, the second bar sub-view, and the third bar sub-view. Each of the first bar sub-view, the second bar sub-view, and the third bar sub-view have been registered for monitoring a side-sliding event.

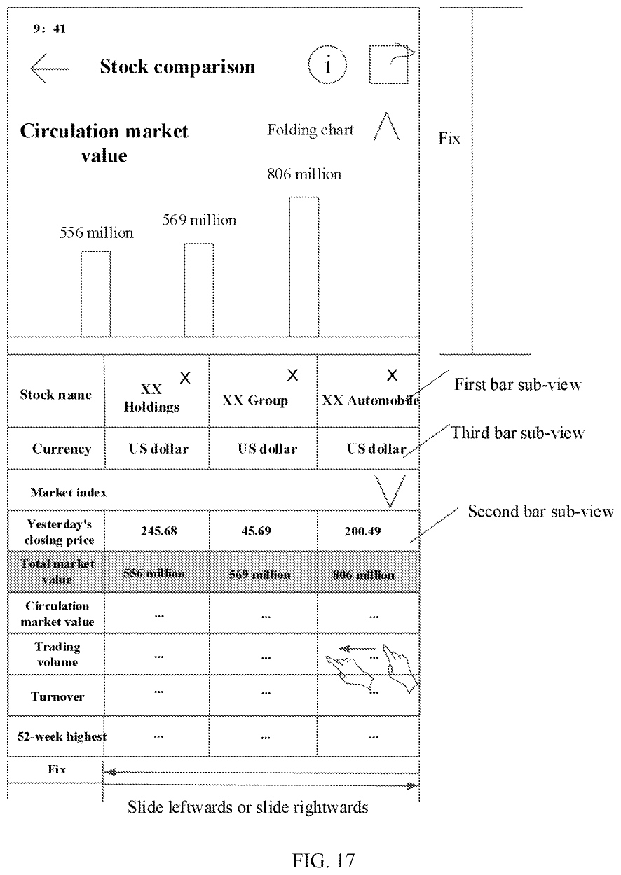

In some embodiments of the present disclosure, FIG. 17 is a schematic diagram illustrating a stock comparison page according to an embodiment of the present disclosure. As shown in FIG. 17, the chart showing view shows a chart (histogram) corresponding to the index of total market value, and the currency is US dollars. In order to achieve the side-sliding, only the first bar sub-view, the second bar sub-view, and the third bar sub-view are needed to be slid, the menu view is fixed, and the part above the row view where the stock name column is located is fixed. Therefore, the stock comparison page can be side-slid only when the user perform the side-sliding in a region where the first bar sub-view, the second bar sub-view, and the third bar sub-view are located.

In an implementation, a synchronous sliding management unit may be provided at the client. The synchronous sliding management unit is a software module of the client, and is responsible for executing the operations at S601 to S603 to realize the synchronous side-sliding of all bar sub-views. In some embodiments of the present disclosure, each of the first bar sub-view, the second bar sub-view, and the third bar sub-view can transmit a registration request to the synchronous sliding management unit. The synchronous sliding management unit is configured to, in response to receiving the registration request, register the first bar sub-view, the second bar sub-view, and the third bar sub-view to monitor an occurrence of a side-sliding event. The synchronous sliding management unit is further configured to monitor the occurrence of the side-sliding event for all the registered bar sub-views.

At S602, a side-sliding direction and a side-sliding distance are determined based on the side-sliding operation.

In this embodiment, the synchronous sliding management unit is further configured to, in response to the user performing the side-sliding operation in the region where the first bar sub-view, the second bar sub-view, or the third bar sub-view are located, monitor the side-sliding event. The side-sliding direction and the side-sliding distance are determined based on the side-sliding event. In some embodiments of the present disclosure, for example, the user performs the side-sliding operation on the bar sub-view, and the side-sliding distance is a distance between a starting point of the finger and an end point of the finger after the side-sliding. The bar sub-view can calculate the side-sliding distance, and the side-sliding direction can be directly monitored as a leftward or rightward direction.

At S603, a side-sliding instruction is transmitted to each of the first bar sub-view, the second bar sub-view, and the third bar sub-view. The side-sliding instruction carries the side-sliding direction and the side-sliding distance and is used for the bar sub-view receiving the side-sliding instruction to slide based on the side-sliding direction and the side-sliding distance.

In some embodiments of the present disclosure, the sliding management unit is further configured to transmit the side-sliding instruction to each of the first bar sub-view, the second bar sub-view, and the third bar sub-view that have been registered by the sliding management unit. The bar sub-view receiving the side-sliding instruction is slid based on the side-sliding direction and the side-sliding distance, thereby realizing the synchronous side-sliding of the bar sub-views without slight sliding deviation among all the bar sub-views.

In this embodiment, the side-sliding events of all registered bar sub-views are monitored by the sliding management unit, and the registered bar sub-views are managed. Therefore, when the side-sliding operation on the bar sub-view from the user is monitored, the side-sliding instruction is transmitted to other bar sub-views, and all bar sub-views are side-slid synchronously. Thus, conflicts can also be avoided. For example, the user performs the sliding through two bar sub-views with his finger, or the user's finger slides at an intersection line of two bar sub-views. When the user touches the two bar sub-views with his finger, there is an order. It can be understood that, a time interval between touching the two bar sub-views by the user's finger is very small. As long as the user's side-sliding operation on the first bar sub-view is monitored by the sliding management unit, the side-sliding instruction can be transmitted to other bar sub-views, so that all bar sub-views can be side-slid synchronously, thus ensuring that there is no slight sliding offset between all bar sub-views.

In some embodiments of the present disclosure, the stock comparison page in the embodiment of the present disclosure can also support a long picture sharing and a short picture sharing. For example, after the user clicks a sharing icon displayed on the page, a multi-picture radio control is evoked, and a long picture or a short picture can be selected to be shared. The short picture sharing is to generate a screenshot sharing of the browsing position of the current page, and the long picture sharing is to generate a screenshot sharing of all contents of the current page.

The following is an embodiment of a data comparison apparatus of the present disclosure, which is configured to implement the above-mentioned method embodiments of the present disclosure. For details not disclosed in apparatus embodiments of the present disclosure, reference may be made to the above method embodiments of the present disclosure.

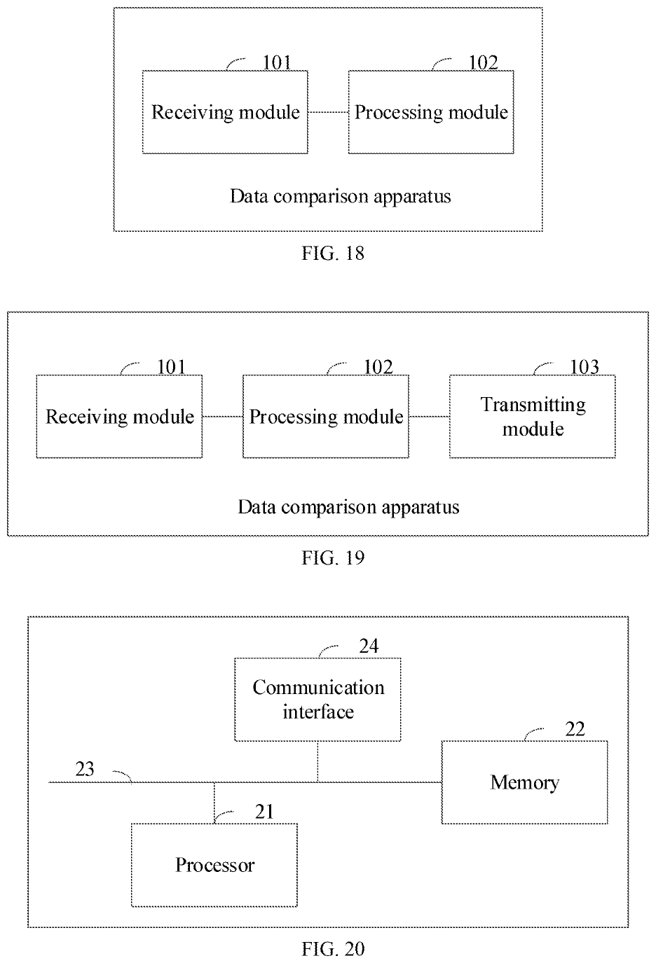

FIG. 18 is a schematic structural diagram of a data comparison apparatus according to an embodiment of the present disclosure. As shown in FIG. 18, the data comparison apparatus of the embodiment may include a receiving module 101 and a processing module 102.

The receiving module 101 is configured to receive a stock comparison instruction in response to a first operation from a user.

The processing module 102 is configured to display a stock comparison page. The stock comparison page includes a menu view row views corresponding to the menu view. The menu view includes a stock name column and a data index selection list column. The data index selection list column includes at least two data indexes, and each of the at least two data indexes including at least one index. A row view corresponding to the stock name column includes at least two first bar sub-views, and each of the at least two first bar sub-views is used to display a button for adding a to-be-compared stock or display a name of the to-be-compared stock and a delete button. Aa row view corresponding to each of the at least one index includes at least two second bar sub-views, and each of the at least two second bar sub-views is used to display data of each of the at least one index of each to-be-compared stock.

The apparatus according to embodiments of the present disclosure can implement the above method embodiments, and the specific implementation principle and technical effect may refer to the above method embodiments, which will be omitted herein.

FIG. 19 is a schematic structural diagram illustrating a data comparison apparatus according to an embodiment of the present disclosure. As shown in FIG. 19, the apparatus of the present embodiment further includes a transmitting module 103.

The transmitting module 103 is configured to transmit a first data request to a server. The first data request carries the name of the to-be-compared stock.

The receiving module 101 is further configured to receive data information of the to-be-compared stock transmitted from a server. The data information of the to-be-compared stock includes the name of the to-be-compared stock and data of at least one index of the to-be-compared stock.

The processing module 102 is configured to display, based on the data information of the to-be-compared stock, the name of the to-be-compared stock on the first bar sub-view and the data of each index on a second bar sub-view corresponding to the index.

In some embodiments of the present disclosure, when a first operation is performed on a first page, the name of the to-be-compared stock includes a name of a pre-stored stock or a name of a stock selected by a user last time.

When the first operation is performed on a second page, the name of the to-be-compared stock includes a name of a current stock on the second page and a name of a stock selected by the user, or includes the name of the stock selected by the user last time.

In some embodiments of the present disclosure, the stock comparison page also includes a chart showing view for displaying a chart corresponding to the data of each index of each to-be-compared stock.

In some embodiments of the present disclosure, the transmitting module 103 is further configured to transmit the first data request to the server. The first data request carries the name of the to-be-compared stock and a target index. The target index is an index of which data is displayed for first-time displaying of the chart.

The receiving module 101 is further configured to receive the data information of the to-be-compared stock transmitted by the server. The data information of the to-be-compared stock includes the name of the to-be-compared stock, the data of at least one index of the to-be-compared stock, and the chart data of the target index of the to-be-compared stock.

The processing module 102 is further configured to display, based on the data information of the to-be-compared stock, the name of each to-be-compared stock on each first bar sub-view and each index data on the second bar sub-view corresponding to each index, and show the chart corresponding to the chart data of the target index on the chart showing view.

In some embodiments of the present disclosure, when the first operation is performed on the first page, the name of the to-be-compared stock includes the name of the pre-stored stock or the name of the stock selected by a user last time, and the target index is a predetermined index.

When the first operation is performed on the second page, the name of the to-be-compared stock is the name of the current stock on the second page and the name of the stock selected by the user or is the name of the stock selected by the user last time, and the target index is a predetermined index.

In some embodiments of the present disclosure, the transmitting module 103 is further configured to transmit a second data request to the server. The second data request carries the first index selected by the user.

The receiving module 101 is further configured receive chart data of the first transmitted by the server.

The processing module 102 is further configured to show a chart corresponding to the chart data of the first index on a chart showing view.

In some embodiments of the present disclosure, the processing module 102 is further configured to, prior to transmitting the first data request to the server by the transmitting module 103: receive an instruction to add the to-be-compared stock in response to a user's operation of clicking a button to add the to-be-compared stock; display a stock adding page, the stock adding page including a selected stock list and a to-be-selected stock list; and determine the name of the stock selected by the user as the name of the to-be-compared stock.

In some embodiments of the present disclosure, the menu view further includes a currency selection column, and a row view corresponding to the currency selection column includes at least one third bar sub-view.

In some embodiments of the present disclosure, the processing module 102 is further configured to monitor a side-sliding operation on a target bar sub-view from the user, and determine a side-sliding direction and a side-sliding distance based on the side-sliding operation. The target bar sub-view is any one of the first bar sub-view, the second bar sub-view, and the third bar sub-view.

The transmitting module 103 is further configured to transmit a side-sliding instruction to each of the first bar sub-view, the second bar sub-view, and the third bar sub-view. The side-sliding instruction carries the side-sliding direction and the side-sliding distance and is configured for the bar sub-view receiving the side-sliding instruction to slide based on the side-sliding direction and the side-sliding distance.

The apparatus according to embodiments of the present disclosure can implement the method as described in the above embodiments, and the specific implementation principle and technical effect may refer to the above method embodiments, and thus the description thereof in detail will be omitted herein.

It should be noted that the division of each module of the above apparatus is only a logical division, and all or part of the actual implementation may be integrated into one physical entity or may be physically separated. In addition, these modules may all be implemented in the form of software invoked by a processing element; or may be implemented in the form of hardware. Further, a part of the modules may be implemented in the form of calling software by the processing element, and a part of the modules may be implemented in the form of hardware. For example, the processing module may be a processing element that is separately configured, or may be integrated into a chip of the apparatus, or may be stored in a memory of the apparatus in the form of program code, and a processing element of the apparatus calls and executes a function of the processing module. The other modules are implemented similarly. In addition, all or part of the modules may be integrated together or may be independently implemented. The processing element may be an integrated circuit having signal processing capabilities. In an implementation, each step of the above method or each module above may be implemented by an integrated logic circuit of hardware in a processor element or an instruction in the form of software.

For example, the above modules may be one or more integrated circuits configured to implement the above methods, and includes for examples one or more Application Specific Integrated Circuits (ASICs), or one or more microprocessors (DSPs), or one or more Field Programmable Gate Arrays (FPGAs), among others. For another example, when some of the above modules are implemented in the form of a processing element scheduler code, the processing element may be a general-purpose processor, such as a Central Processing Unit (CPU) or other processor capable of calling program code. As another example, these modules may be integrated together and implemented in the form of a system-on-a-chip (SOC).

In the above embodiments, all or part of the implementations may be implemented by software, hardware, firmware, or any combination thereof. When implemented in the software, it may be implemented in whole or partially in the form of a computer program product. The computer program product includes one or more computer instructions. The procedures or functions according to the embodiments of the present application are all or partially generated when the computer program instructions are loaded and executed on a computer. The computer may be a general purpose computer, a special purpose computer, a network of computers, or other programmable device. The computer instructions may be stored in a computer readable storage medium or transmitted from one computer readable storage medium to another computer readable storage medium. For example, the computer instructions may be transmitted from one website, computer, server, or data center to another website, computer, server, or data center in a wired (e.g., coaxial cable, fiber optic, Digital Subscriber Line (DSL)) or wireless (e.g., infrared, wireless, microwave, etc.) manner. A computer-readable storage medium may be any available media accessed by a computer or a data storage device, such as a server, data center, etc., that includes one or more available medium. The available medium may be a magnetic medium (e.g., a floppy disk, a hard disk, a magnetic tape), an optical medium (e.g., a DVD), or a semiconductor medium (e.g., a Solid State Disk (SSD)), and the like.

FIG. 20 is a schematic structural diagram of an electronic device according to an embodiment of the present disclosure. As shown in FIG. 20, the electronic device of the present embodiment may include a processor 21 and a memory 22.

The memory 22 is configured to store instructions executable by the processor 21.

The processor 21 is configured to execute the executable instructions to perform the data comparison method as described above.

In some embodiments of the present disclosure, the memory 22 may be either independent or integrated with the processor 21.

When the memory 22 is a device independent of the processor 21, the electronic device of the present embodiment may further include a bus 23 configured to connect the memory 22 to the processor 21.

In some embodiments of the present disclosure, the electronic device of the present embodiment may further include a communication interface 24 connected to the processor 21 via the bus 23.

The present disclosure also provides a computer-readable storage medium having computer executable instructions stored thereon. The computer executable instructions, when executed by the computer, cause the computer to execute the data comparison method as described above.

Embodiments of the present disclosure also provide a computer program product including a computer program. The computer program, when executed by a processor, implements the data comparison method as described above.

In the description of this specification, descriptions with reference to the terms “an embodiment”, “some embodiments”, “illustrative embodiments”, “an example”, “a specific example”, “some examples”, etc., mean that specific features, structure, materials, or characteristics described in conjunction with the embodiment or example are included in at least one embodiment or example of the present disclosure. In this specification, the schematic representations of the above terms do not necessarily refer to the same embodiment or example. Moreover, the described specific features, structures, materials or characteristics may be combined in any one or more embodiments or examples in a suitable manner. In addition, different embodiments or examples and features of different embodiments or examples described in the specification may be combined by those skilled in the art without mutual contradiction.

Although embodiments of present disclosure have been shown and described above, it should be understood that above embodiments are just explanatory, and cannot be construed to limit the present disclosure, for those skilled in the art, changes, modifications, alternatives, and variations can be made to the embodiments within the scope of the present disclosure.

What is claimed is:

1. A data comparison method, comprising:
receiving a stock comparison instruction in response to a first operation from a user, the first operation being the user clicking a stock comparison button or icon displayed on a page of a stock application (APP); and
displaying a stock comparison page,
wherein the stock comparison page comprises:
a menu view comprising a stock name column and a data index selection list column, the data index selection list column comprising at least two data indexes, each of the at least two data indexes comprising at least one index; and
row views corresponding to the menu view, wherein:
a row view corresponding to the stock name column comprises at least two first bar sub-views, each of the at least two first bar sub-views being used to display a button for adding a to-be-compared stock or display a name of the to-be-compared stock and a delete button; and
a row view corresponding to each of the at least one index comprises at least two second bar sub-views, each of the at least two second bar sub-views being used to display data of each of the at least one index of each to-be-compared stock, wherein:
the button for adding the to-be-compared stock is configured to, in response to a use's clicking on the button for adding the to-be-compared stock, add the to-be-compared stock through a stock adding page, and the delete button is configured to, in response to a use's clicking on the delete button, delete the name of the to-be-compared stock displayed on the first bar sub-view;
the data indexes comprises a market index, a valuation index, an analysis index, a financial index, and financial data, wherein for each of the data indexes, an coin for triggering expanding or folding of the index of the date index is provided on a sub-view where the date index is located;
the menu view further comprises a currency selection column;
a row view corresponding to the currency selection column comprises at least one third bar sub-view;
a side-sliding operation on a target bar sub-view from the user is monitored, the target bar sub-view being any one of the first bar sub-view, the second bar sub-view, and the third bar sub-view, each of the first bar sub-view, the second bar sub-view, and the third bar sub-view having been registered for monitoring a side-sliding event;
a side-sliding direction and a side-sliding distance are determined based on the side-sliding operation; and
a side-sliding instruction is transmitted to the first bar sub-view, the second bar sub-view, and the third bar sub-view, the side-sliding instruction carrying the side-sliding direction and the side-sliding distance and being used for the bar sub-view receiving the side-sliding instruction to slide based on the side-sliding direction and the side-sliding distance.

2. The method according to claim 1, further comprising:
transmitting a first data request to a server, the first data request carrying the name of the to-be-compared stock;
receiving data information of the to-be-compared stock transmitted from the server, the data information of the to-be-compared stock comprising the name of the to-be-compared stock and data of the at least one index of the to-be-compared stock; and
displaying, based on the data information of the to-be-compared stock, the name of the to-be-compared stock on each of the at least two first bar sub-view, and the data of each of the at least one index on a second bar sub-view corresponding to the index.

3. The method according to claim 2, wherein:
when the first operation is performed on a first page, the name of the to-be-compared stock comprises a name of a pre-stored stock or a name of a stock selected by the user last time; and
when the first operation is performed on a second page, the name of the to-be-compared stock comprises a name of a current stock on the second page and a name of a stock selected by the user, or comprises the name of the stock selected by the user last time.

4. The method according to claim 2, further comprising, prior to transmitting the first data request to the server:
determining, in response to determining that first operation is performed on the second page, the name of the current stock on the second page as the name of the to-be-compared stock; and
displaying, in response to the first operation is performed on a page except the second page, the button for adding the to-be-compared stock on each of the at least two first bar sub-views.

5. The method according to claim 1, wherein the stock comparison page further comprises a chart showing view for showing a chart corresponding to the data of each of the at least one index of each to-be-compared stock.

6. The method according to claim 5, further comprising:
transmitting a first data request to a server, the first data request carrying the name of the to-be-compared stock and a target index of the to-be-compared stock, the target index being an index of which data is displayed for first-time displaying of the chart;
receiving data information of the to-be-compared stock transmitted from the server, the data information of the to-be-compared stock comprising a name of the to-be-compared stock, data of at least one index of the to-be-compared stock, and chart data of the target index of the to-be-compared stock;
displaying, based on the data information of the to-be-compared stock, the name of the to-be-compared stock on each of the at least two first bar sub-views and the data of each of the at least one index on a second bar sub-view corresponding to the index; and
showing, based on pre-stored correspondence between indexes and chart types, a chart corresponding to chart data of the target index on the chart showing view.

7. The method according to claim 6, wherein said displaying, based on the pre-stored correspondence between indexes and chart types, the chart corresponding to the chart data of the target index on the chart showing view comprises:
determining a type of a chart corresponding to the target index based on the pre-stored correspondence between indexes and chart types;
converting the chart data of the target index based on the chart type corresponding to the target index, to obtain the converted chart data of the target index; and
showing a chart corresponding to the converted chart data of the target index on the chart showing view.

8. The method according to claim 6, wherein:
when the first operation is performed on a first page, the name of the to-be-compared stock comprises a name of a pre-stored stock or a name of a stock selected by a user last time, and the target index is a predetermined index;
when the first operation is performed on a second page, the name of the to-be-compared stock comprises a name of a current stock on the second page and a name of the stock selected by the user, or comprises the name of the stock selected by the user last time, and the target index is the predetermined index.

9. The method according to claim 6, further comprising:
transmitting a second data request to the server, the second data request carrying a first index selected by a user;
receiving chart data of the first index transmitted from the server; and
showing a chart corresponding to the chart data of the first index on the chart showing view.

10. The method according to claim 2, further comprising, prior to said transmitting the first data request to the server:
receiving, in responding to a user's operation of clicking the button for adding a to-be-compared stock, an instruction for adding a to-be-compared stock;
displaying the stock adding page, the stock adding page comprising a selected stock list and a to-be-selected stock list, the to-be-selected stock list comprising names of a plurality of stocks to be selected by the user; and
determining a name of a stock selected by the user as the name of the to-be-compared stock.

11. The method according to claim 10, further comprising:
determining a to-be-recommended stock based on a predetermined index and/or stock attribute information of a stock in the selected stock list; and
determining the to-be-recommended stock as a to-be-selected stock in the to-be-selected stock list, a display priority of the to-be-recommended stock being higher than display priorities of other stocks to be selected.

12. The method according to claim 11, wherein when a plurality of predetermined indexes is provided, said determining the to-be-recommended stock based on the predetermined index of the stock in the selected stock list comprises:
determining a stock, for which a difference between a weighted average of the plurality of predetermined indexes of the stock and a weighted average of the plurality of predetermined indexes of the stock in the selected stock list is smaller than or equal to a predetermined threshold, as the to-be-recommended stock.

13. A data comparison apparatus, comprising:
a receiving module configured to receive a stock comparison instruction in response to a first operation from a user, the first operation being the user clicking a stock comparison button or icon displayed on a page of a stock application (APP); and
a processing module configured to display a stock comparison page, wherein the stock comparison page comprises:
a menu view comprising a stock name column and a data index selection list column, the data index selection list column comprising at least two data indexes, each of the at least two data indexes comprising at least one index; and
row views corresponding to the menu view, wherein:
a row view corresponding to the stock name column comprises at least two first bar sub-views, each of the at least two first bar sub-views being used to display a button for adding a to-be-compared stock or display a name of the to-be-compared stock and a delete button; and
a row view corresponding to each of the at least one index comprises at least two second bar sub-views, each of the at least two second bar sub-views being used to display data of each of the at least one index of each to-be-compared stock, wherein:
the button for adding the to-be-compared stock is configured to, in response to a use's clicking on the button for adding the to-be-compared stock, add the to-be-compared stock through a stock adding page, and the delete button is configured to, in response to a use's clicking on the delete button, delete the name of the to-be-compared stock displayed on the first bar sub-view;
the data indexes comprises a market index, a valuation index, an analysis index, a financial index, and financial data, wherein for each of the data indexes, an coin for triggering expanding or folding of the index of the date index is provided on a sub-view where the date index is located;
the menu view further comprises a currency selection column;
a row view corresponding to the currency selection column comprises at least one third bar sub-view;
a side-sliding operation on a target bar sub-view from the user is monitored, the target bar sub-view being any one of the first bar sub-view, the second bar sub-view, and the third bar sub-view, each of the first bar sub-view, the second bar sub-view, and the third bar sub-view having been registered for monitoring a side-sliding event;
a side-sliding direction and a side-sliding distance is determined based on the side-sliding operation; and
a side-sliding instruction is transmitted to the first bar sub-view, the second bar sub-view, and the third bar sub-view, the side-sliding instruction carrying the side-sliding direction and the side-sliding distance and being used for the bar sub-view receiving the side-sliding instruction to slide based on the side-sliding direction and the side-sliding distance.

14. An electronic device, comprising:
a processor; and
a memory configured to store instructions executable by the processor,
wherein the processor is configured to execute the executable instructions to cause the electronic device to:
receive a stock comparison instruction in response to a first operation from a user, the first operation being the user clicking a stock comparison button or icon displayed on a page of a stock application (APP); and
display a stock comparison page,
wherein the stock comparison page comprises:
a menu view comprising a stock name column and a data index selection list column, the data index selection list column comprising at least two data indexes, each of the at least two data indexes comprising at least one index; and
row views corresponding to the menu view, wherein:
a row view corresponding to the stock name column comprises at least two first bar sub-views, each of the at least two first bar sub-views being used to display a button for adding a to-be-compared stock or display a name of the to-be-compared stock and a delete button; and
a row view corresponding to each of the at least one index comprises at least two second bar sub-views, each of the at least two second bar sub-views being used to display data of each of the at least one index of each to-be-compared stock, wherein:
the button for adding the to-be-compared stock is configured to, in response to a use's clicking on the button for adding the to-be-compared stock, add the to-be-compared stock through a stock adding page, and the delete button is configured to, in response to a use's clicking on the delete button, delete the name of the to-be-compared stock displayed on the first bar sub-view;
the data indexes comprises a market index, a valuation index, an analysis index, a financial index, and financial data, wherein for each of the data indexes, an coin for triggering expanding or folding of the index of the date index is provided on a sub-view where the date index is located;
the menu view further comprises a currency selection column;
a row view corresponding to the currency selection column comprises at least one third bar sub-view;
a side-sliding operation on a target bar sub-view from the user is monitored, the target bar sub-view being any one of the first bar sub-view, the second bar sub-view, and the third bar sub-view, each of the first bar sub-view, the second bar sub-view, and the third bar sub-view having been registered for monitoring a side-sliding event;
a side-sliding direction and a side-sliding distance are determined based on the side-sliding operation; and
a side-sliding instruction is transmitted to the first bar sub-view, the second bar sub-view, and the third bar sub-view, the side-sliding instruction carrying the side-sliding direction and the side-sliding distance and being used for the bar sub-view receiving the side-sliding instruction to slide based on the side-sliding direction and the side-sliding distance.

15. The electronic device according to claim 14, wherein the processor is further configured to execute the Zexecutable instructions to cause the electronic device to:
transmit a first data request to a server, the first data request carrying the name of the to-be-compared stock;
receive data information of the to-be-compared stock transmitted from the server, the data information of the to-be-compared stock comprising the name of the to-be-compared stock and data of the at least one index of the to-be-compared stock; and
display, based on the data information of the to-be-compared stock, the name of the to-be-compared stock on each of the at least two first bar sub-view, and the data of each of the at least one index on a second bar sub-view corresponding to the index.

16. The electronic device according to claim 15, wherein:
when the first operation is performed on a first page, the name of the to-be-compared stock comprises a name of a pre-stored stock or a name of a stock selected by a user last time; and
when the first operation is performed on a second page, the name of the to-be-compared stock comprises a name of a current stock on the second page and a name of a stock selected by the user, or comprises the name of the stock selected by the user last time.

17. The electronic device according to claim 15, wherein the processor is further configured to execute the executable instructions to cause the electronic device to, prior to transmitting the first data request to the server:
determine, in response to determining that first operation is performed on the second page, the name of the current stock on the second page as the name of the to-be-compared stock; and
display, in response to the first operation is performed on a page except the second page, the button for adding the to-be-compared stock on each of the at least two first bar sub-views.

18. The electronic device according to claim 14, wherein the stock comparison page further comprises a chart showing view for showing a chart corresponding to the data of each of the at least one index of each to-be-compared stock.

19. The electronic device according to claim 18, wherein the processor is further configured to execute the executable instructions to cause the electronic device to:
transmit a first data request to a server, the first data request carrying the name of the to-be-compared stock and a target index of the to-be-compared stock, the target index being an index of which data is displayed for first-time displaying of the chart;
receive data information of the to-be-compared stock transmitted from the server, the data information of the to-be-compared stock comprising a name of the to-be-compared stock, data of at least one index of the to-be-compared stock, and chart data of the target index of the to-be-compared stock;
display, based on the data information of the to-be-compared stock, the name of the to-be-compared stock on each of the at least two first bar sub-views and the data of each of the at least one index on a second bar sub-view corresponding to the index; and
show, based on pre-stored correspondence between indexes and chart types, a chart corresponding to chart data of the target index on the chart showing view.

20. A computer-readable storage medium, having a computer program stored thereon, wherein the computer program, when executed by a processor, implements the data comparison method according to claim 1.
